(19) United States
(12) Patent Application Publication
(10) Pub. No.: US 2019/0143281 A1
(43) Pub. Date: May 16, 2019

(54) SYSTEM AND METHOD FOR AERATING A FLUID

(71) Applicant: Plasma Environmental LLC, Bayside, WI (US)

(72) Inventor: Paul Goudy, Bayside, WI (US)

(21) Appl. No.: 16/193,811

(22) Filed: Nov. 16, 2018

Related U.S. Application Data
(60) Provisional application No. 62/748,059, filed on Oct. 19, 2018.
(60) Provisional application No. 62/693,143, filed on Jul. 2, 2018.
(60) Provisional application No. 62/646,568, filed on Mar. 22, 2018.
(60) Provisional application No. 62/587,087, filed on Nov. 16, 2017.

(51) Int. Cl. B01F 3/04; B01F 7/00; B01F 7/18

(52) U.S. Cl. CPC B01F 3/04539; B01F 3/04617; B01F 7/007; B01F 2003/04631; B01F 2003/04546; B01F 2003/04673; B01F 7/186

(57) ABSTRACT

An aeration system including a frame and an aerator. The aerator may be supported by the frame. The aerator may include an input and an output. The aerator may be configured to rotate with respect to the frame, and upon rotating, receive a first fluid at the input and output the first fluid into a second fluid at the output.

### RELATED APPLICATIONS

This application claims the benefit to U.S. Provisional Patent Application No. 62/587,087, filed on Nov. 16, 2017; U.S. Provisional Patent Application No. 62/646,568, filed on Mar. 22, 2018; U.S. Provisional Patent Application No. 62/693,143, filed on Jul. 2, 2018; and U.S. Provisional Patent Application No. 62/748,059, filed on Oct. 19, 2018, the entire contents of which are all incorporated herein by reference.

### FIELD

Embodiments relate to systems and methods for aerating a fluid.

### SUMMARY

A first fluid (for example, water) may be aerated to increase the content of a second fluid (for example, air including oxygen, nitrogen, etc.) within the first fluid.

One embodiment provides an aeration system including a frame and an aerator. The aerator may be supported by the frame. The aerator may include an input and an output. The aerator may be configured to rotate with respect to the frame, and upon rotating, receive a first fluid at the input and output the first fluid into a second fluid at the output.

In some embodiments, the aerator includes one or more vanes. Upon rotating the aerator, the input may be formed by a top portion of the one or more vanes and the output may be formed by a bottom portion of the one or more vanes. The top portion of the one or more vanes may be located above a surface of the second fluid and the bottom portion of the one or more vanes may be located below the surface of the second fluid. In some embodiments, the one or more vanes include a first vane extending in a first direction and a second vane extending in a second direction. In some embodiments, the first direction and the second direction are perpendicular to each other.

In some embodiments, the input and the output are in fluid communication via a channel. The channel may be formed by rotation of one or more vanes.

In some embodiments, the input includes one or more scoops. The one or more scoops may include a first scoop projected in a first direction and a second scoop projected in a second direction. The first direction may be opposite the second direction.

In some embodiments, the aeration system may further include a stator. The stator may have one or more fins located proximate the output.

In some embodiments, the aeration system may further include a second output. The second output may be perpendicular to the output.

Another embodiment provides a method of aerating a first fluid with a second fluid. The method may include providing an aerator including an input and an output, and rotating the aerator. The method may also include upon rotating the aerator, receiving the first fluid at the input and outputting the first fluid into the second fluid at the output.

It is contemplated that any of the above embodiments may be combined with each other or any embodiments disclosed herein. Other aspects of the application will become apparent by consideration of the detailed description and accompanying drawings.

### BRIEF DESCRIPTION OF THE DRAWINGS

FIG. 1 is a perspective view of an aeration system according to some embodiments.

FIG. 2 is a front view of the aeration system of FIG. 1 according to some embodiments.

FIG. 3 is a front view of an aerator of the aeration system of FIG. 1 according to some embodiments.

FIG. 4 is a perspective view of a frame of the aeration system of FIG. 1 according to some embodiments.

FIG. 5 is a perspective view of a top portion of the frame of FIG. 4 according to some embodiments.

FIG. 6 is a perspective view of a bottom portion of the frame of FIG. 4 according to some embodiments.

FIG. 7 is a perspective view of a frame according to another embodiment.

FIG. 8 is a perspective view of a bottom portion of the aeration system of FIG. 1 according to some embodiments of operation.

FIG. 9 is a front view of an aeration system according to another embodiment.

FIG. 10 is a side schematic view of an aeration system according to another embodiment.

FIG. 11 is a perspective view of the aeration system of FIG. 10 according to some embodiments.

FIG. 12 is a perspective view of an input, including air scoops, of the aeration system of FIG. 10 according to some embodiments.

FIG. 13 is a side schematic view of an air scoop of FIG. 12 according to some embodiments.

FIG. 14 is a front view of an aeration system according to some embodiments.

FIG. 15 is a top view of a stator of the aeration system of FIG. 15 according to some embodiments.

FIG. 16 is a top view of one or more outputs and one or more fins of the aeration system of FIG. 14 according to some embodiments.

FIG. 17 is a front view of an aeration system according to some embodiments.

FIG. 18 is a side view of an output apparatus of the aeration system of FIG. 17 according to some embodiments.

FIG. 19 is a top view of the output apparatus of FIG. 18 according to some embodiments.

FIG. 20 is a perspective view of an aeration system according to some embodiments.

FIG. 21 is an enlarged view of a portion of an aerator of the aeration system of FIG. 20 according to some embodiments.

FIG. 22 is a side view of the aerator of the aeration system of FIG. 20 according to some embodiments.

FIGS. 23A & 23B are top view of the aerator of the aeration system of FIG. 20 according to some embodiments.

FIG. 24 is a side view of the aeration system of FIG. 20 used as a fluid pump according to some embodiments.

FIG. 25 illustrates a shape of an aerator according to some embodiments.

### DETAILED DESCRIPTION

Before any embodiments of the application are explained in detail, it is to be understood that the application is not limited in its application to the details of construction and the arrangement of components set forth in the following description or illustrated in the following drawings. The application is capable of other embodiments and of being practiced or of being carried out in various ways.

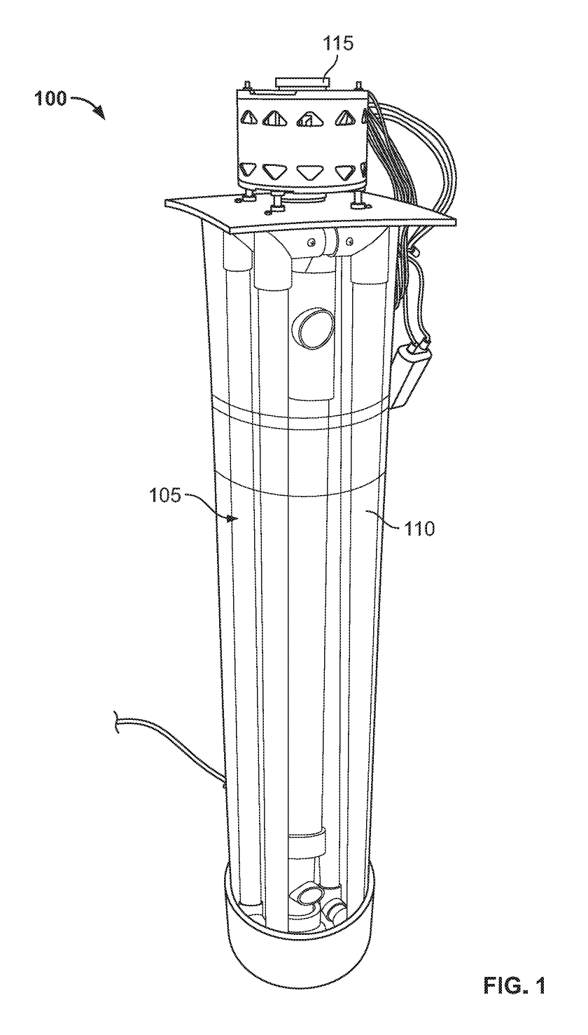

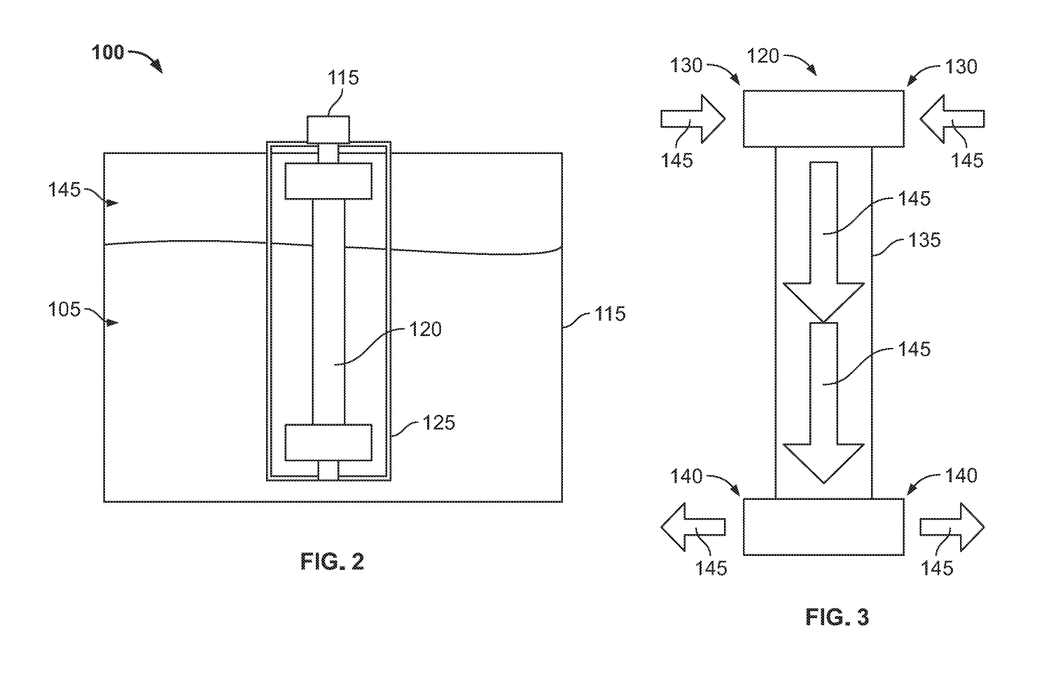

FIGS. 1 and 2 illustrate an aeration system 100 according to some embodiments. The aeration system 100 may be configured to aerate a first fluid 105 within a tank 110. The first fluid 105 may be any fluid, including but not limited to, water. Although illustrated in FIG. 1 as being slightly larger than the aeration system 100, in other embodiments (such as FIG. 2), the tank 110 may be substantially larger than the aeration system 100.

The aeration system 100 may include a motor 115, an aerator 120, and a baffle, or frame, 125. The motor 115 may be any actuator that applies a force (for example, a rotational force). The motor 115 may be, but is not limited to, an alternating-current motor, an alternating-current synchronous motor, an alternating-current induction motor, a direct-current motor, a commutator direct-current motor (for example, permanent-magnet direct-current motors, wound field direct-current motors, etc.), and a reluctance motor (for example, switched reluctance motors). The motor is configured to rotationally drive the aerator 120.

As illustrated in FIG. 3, the aerator 120 may include one or more inputs 130, an intermediary portion 135, and one or more outputs 140. The one or more inputs 130, the intermediary portion 135, and the one or more outputs 140 may be in fluid communication with each other. Although illustrated as being substantially perpendicular to the intermediary portion 135, in other embodiments, the one or more inputs 130 and/or one or more outputs 140 may be coupled to the intermediary portion 135 in another manner and/or position. Furthermore, although illustrated as extending from the intermediary portion 135, in other embodiments, the one or more inputs 130 and/or one or more outputs 140 may be flush with the intermediary portion 135. The one or more inputs 130 and/or one or more outputs 140 may have a predetermined size. In some embodiments, the predetermined size may range from approximately one-inch to approximately one-foot. In other embodiments, the predetermined size may have a smaller or larger diameter.

In operation, second fluid 145 (for example, air, ionized air, etc.) is input into the one or more inputs 130. The second fluid 145 travels through the intermediary portion 135 and is output into the fluid to be aerated 105 via the one or more outputs 140. As the second fluid 145 is input into the fluid to be aerated 105, the fluid to be aerated 105 may be aerated. In some embodiments of operation, the second fluid 145 is input into the aerator 120 via centrifugal force from the rotation of the aerator 120 via the motor 115. For example, as the one or more inputs 130 are exposed to the second fluid 145 and driven rotationally, the second fluid 145 is forced into the one or more inputs 130. The centrifugal force further forces the second fluid 145 through the intermediary portion 135 and out the one or more outputs 140.

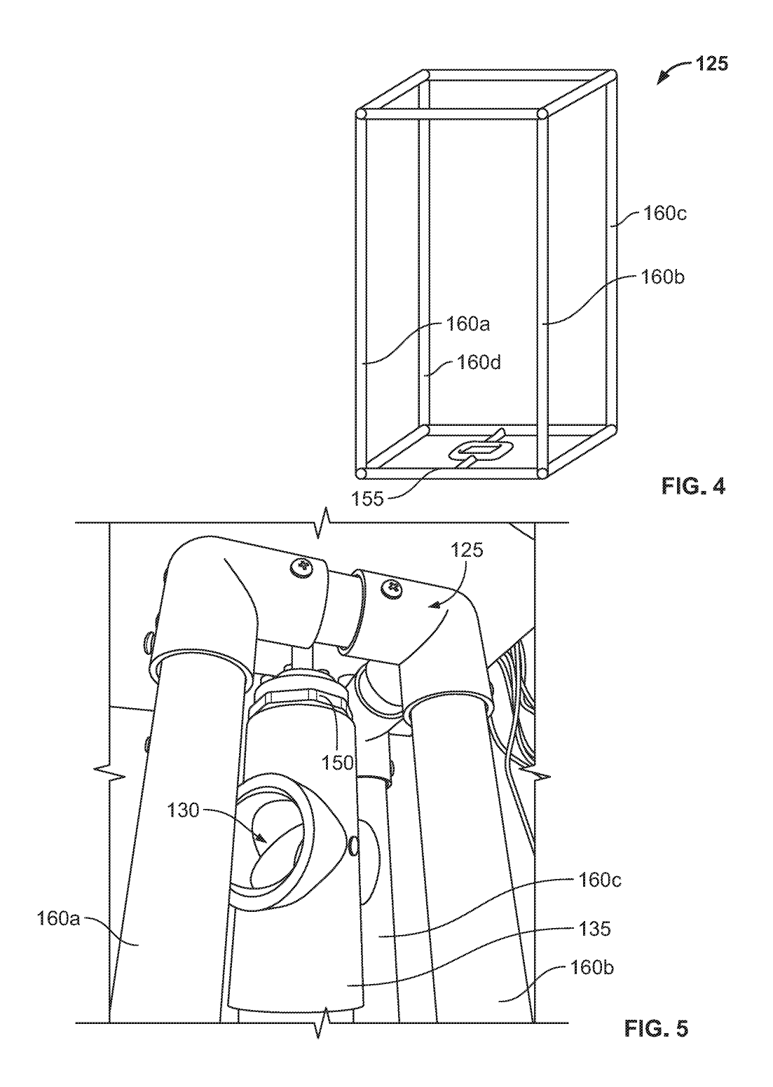

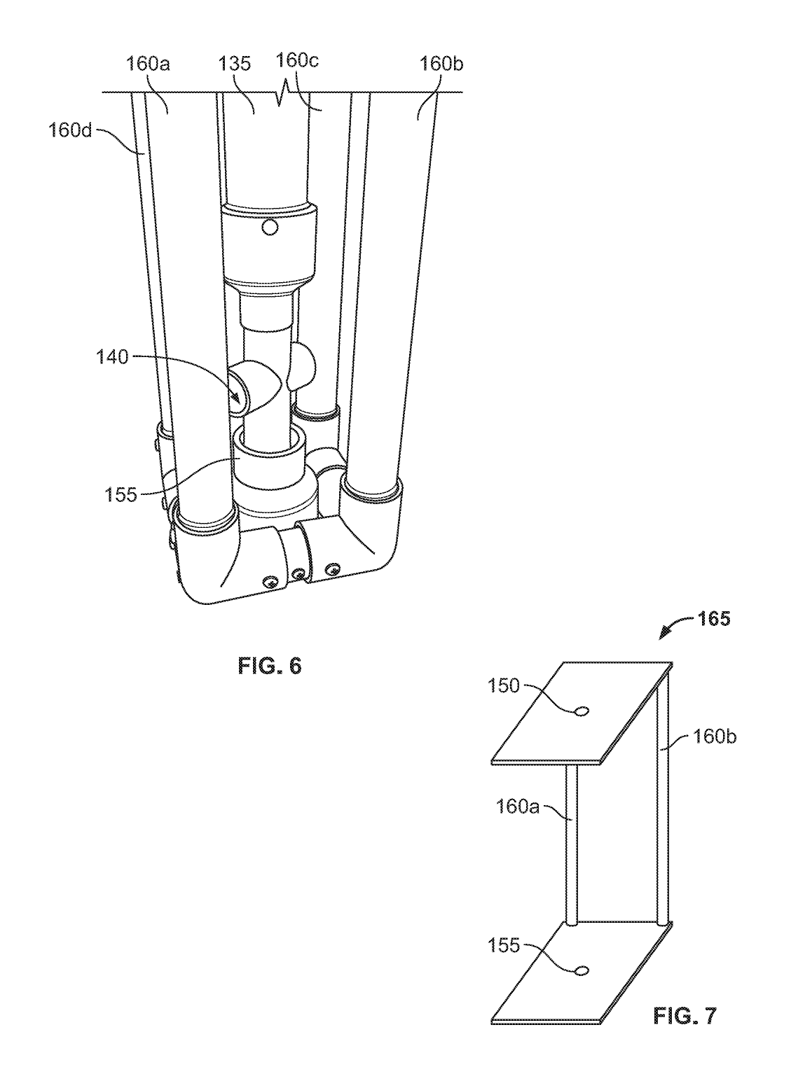

As illustrated in FIGS. 4-6, the frame 125 is configured to secure the aerator 120 while allowing rotational movement of the aerator 120. The frame 125 includes a top coupler 150, a bottom coupler 155, and one or more legs 160a-160d. As illustrated in FIGS. 5 and 6, the aerator 120 is rotationally coupled to the frame 125 via a top coupler 150 and a bottom coupler 155. The top coupler 150 secures a top portion of the aerator 120 while allowing rotational movement to be transferred from the motor 115 to the aerator 120. The bottom coupler 155 secures a bottom portion of the aerator 120 while allowing rotational movement of the aerator 120. In some embodiments, the top coupler 150 and the bottom coupler 155 may include a bearing (for example, a rolling-element bearing, a ball bearing, a roll bearing, a jewel bearing, a magnetic bearing, and a fluid bearing). FIG. 7 illustrates a frame 165 according to another embodiment. In the illustrated embodiment, frame 165 includes the top coupler 150, the bottom coupler 155, a first leg 160a, and a second leg 160b. In yet another embodiment, the frame may include a single leg 160.

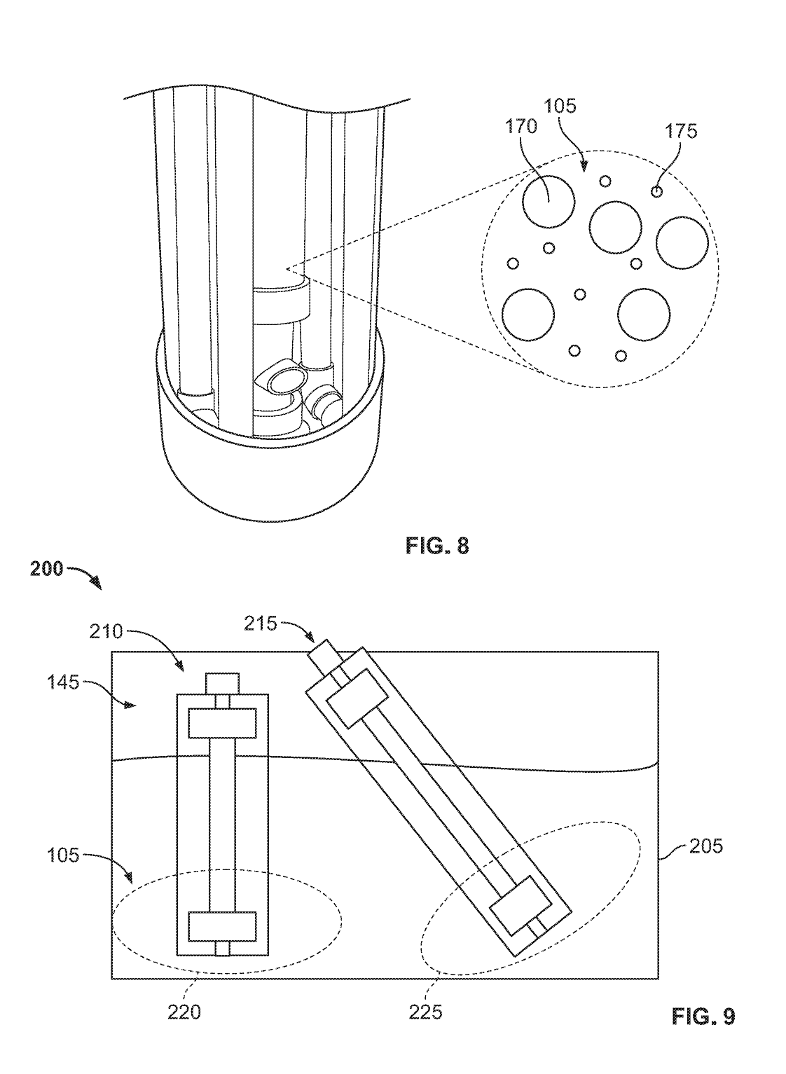

In operation, as the aerator 120 is rotationally driven in relation to the one or more legs 160 of the frame 125, the second fluid 145 enters the one or more inputs 130, travels through the intermediary portion 135, and exits the one or more outputs 140. As the second fluid 145 exits the one or more outputs 140, the second fluid 145 is agitated by the one or more legs 160. As illustrated in FIG. 8, agitation of the second fluid 145, as the second fluid 145 exits the one or more outputs 140, produces a first plurality of bubbles 170 and a second plurality of bubbles 175. In some embodiments, the agitation of the second fluid 145 is caused by a shear strain on the second fluid 145. In such an embodiment, the shear strain may be a result of the one or more outputs 140 being rotationally driven past the one or more legs 160 while the legs 160 are proximate the one or more outputs 140. In some embodiments, the one or more outputs 140 are within a predetermined distance from the legs 160. In some embodiments, the predetermined distance is approximately 0.5 inch to approximately one-foot. In other embodiments, the predetermined distance may be less than or greater than 0.5 inch to one-foot. In some embodiments, the one or more legs 160 may agitate the second fluid 145 by prohibiting a flow of the second fluid 145 as the second fluid 145 exits the one or more outputs 140.

In some embodiments, the first plurality of bubbles 170 are larger than the second plurality of bubbles 175. In some embodiments, the first plurality of bubbles 170 may be configured to mix the first fluid 105, while the second plurality of bubbles 175 may be configured to aerate the first fluid 105.

FIG. 9 illustrates a system 200 according to some embodiments. The system 200 includes a tank 205 containing the first fluid 105. The system 200 further includes a first aeration system 210 and a second aeration system 215. In the illustrated embodiment, the first aeration system 210 is at a first angle (for example, approximately 90°), while the second aeration system 215 is at a second angle (for example, approximately 45°). In such an embodiment, the first aeration system 210 may provide aeration and/or mixing in a first portion 220 of the first fluid 105, while the second aeration system 215 may provide aeration and/or mixing in a second portion 225 of the first fluid 105.

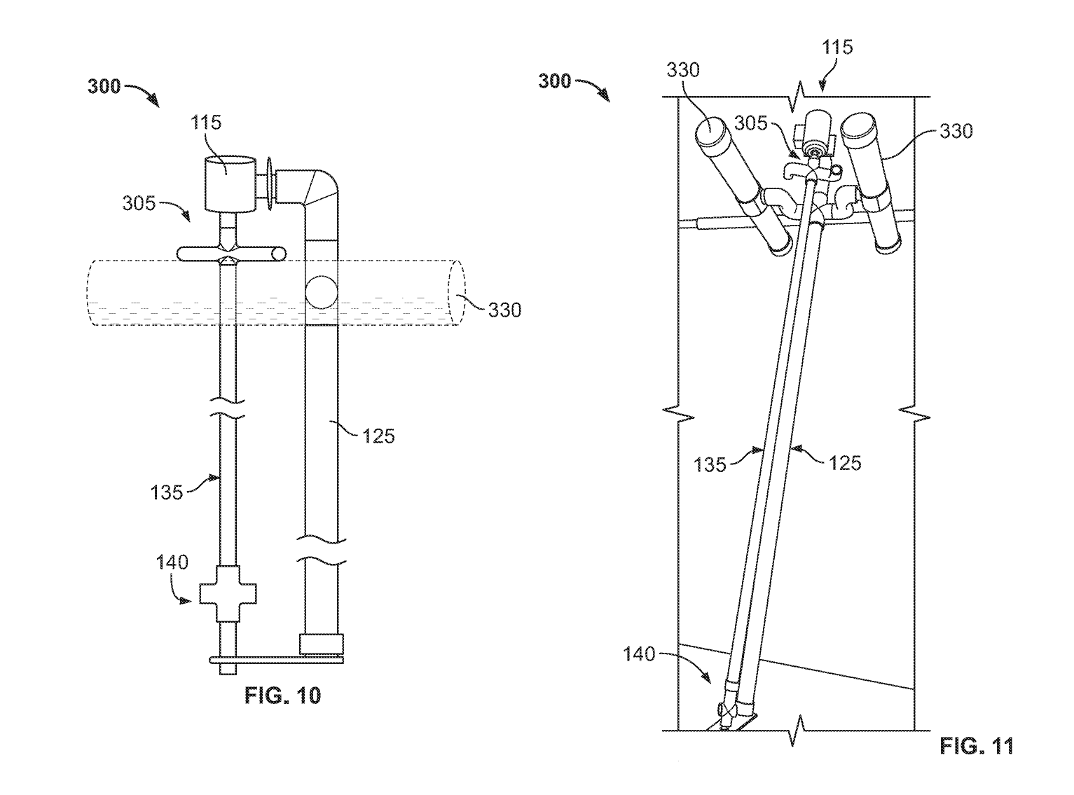

FIGS. 10 and 11 illustrate an aeration system 300 according to other embodiments. The aeration system 300 includes a motor 115, an aerator 120, and a frame 125. The motor 115, aerator 120, and frame 125 may be substantially similar to the embodiments described above. Additionally, in some embodiments, the aeration system 300 may operate substantially similar to aeration system 100 discussed above. Additionally, components of the aeration system 300 may be interchangeable with the above described embodiments.

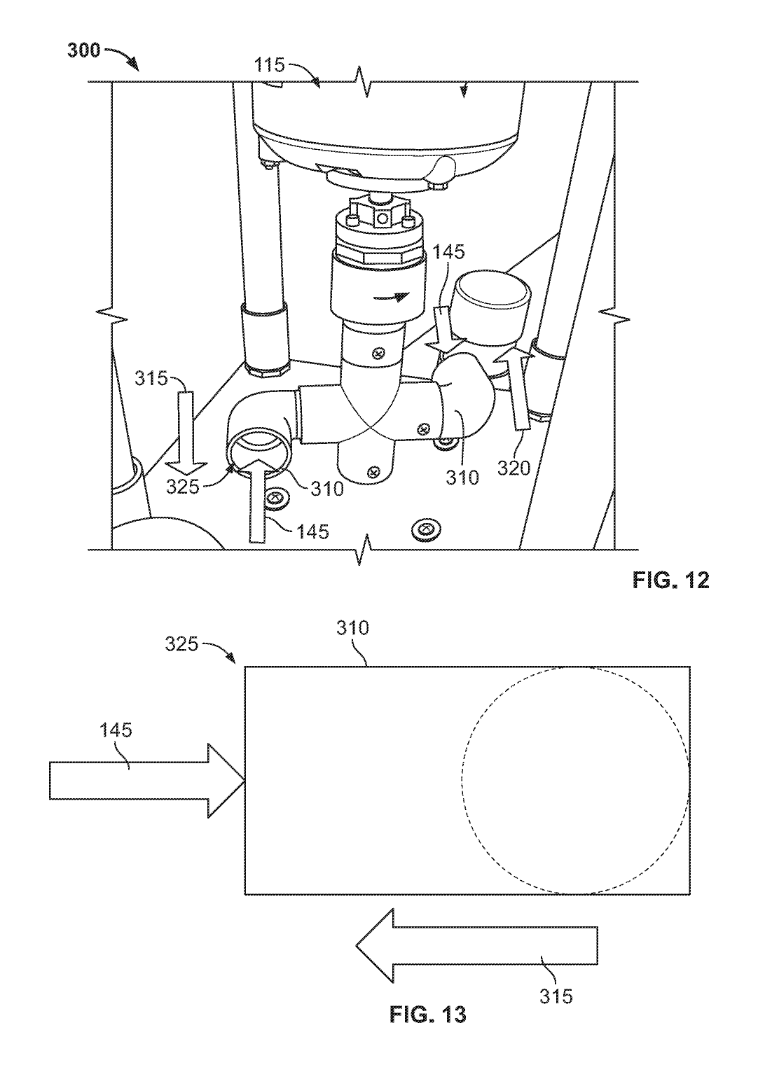

FIG. 12 illustrates an input 305 of the aeration system 300 according to some embodiments. In some embodiments, input 305 is substantially similar to input 130 as described above. Input 305 may further include one or more scoops, or air scoops, 310. As illustrated air scoop 310a extends from the input 130 at a first direction 315, while air scoop 310b extends from the input in a second direction 320. In some embodiments, the second direction 320 is opposite the first direction 315. Additionally, in some embodiments, the first and second air scoops 310a, 310b are on the same plane. The one or more air scoops 310 include air scoop inputs 325 configured to receive the second fluid 145.

FIG. 13 illustrates a side view of a scoop 310 according to some embodiments. As illustrated in FIGS. 12 and 13, the second fluid 145 enters the air scoop input 325 at parallel direction. In operation, as the input 305, and thus the air scoop 310 and air scoop input 325, is rotated by motor 115, the second fluid 145 is forced into the one or more air scoops 310. The second fluid 145 is then pumped through the intermediary portion 135 and is pumped out of the one or more outputs 140. In some embodiments, the second fluid 145 may be pumped at approximately 30 psi from the one or more outputs 140. Additionally, in some embodiments, the motor 115 may operate at approximately 1500 RPM to approximately 3500 RPM (for example, approximately 1725 RPM, approximately 3400 RPM, etc.).

Returning to FIGS. 10 and 11, the aeration system 300 may further include one or more floats 330. The one or more floats 330 are configured to suspend the aeration system 300 in the first fluid 105 contained within the tank 110. In some embodiments, the one or more floats 330 are releasably coupled to the aeration system 300 at a top portion of the aeration system 300.

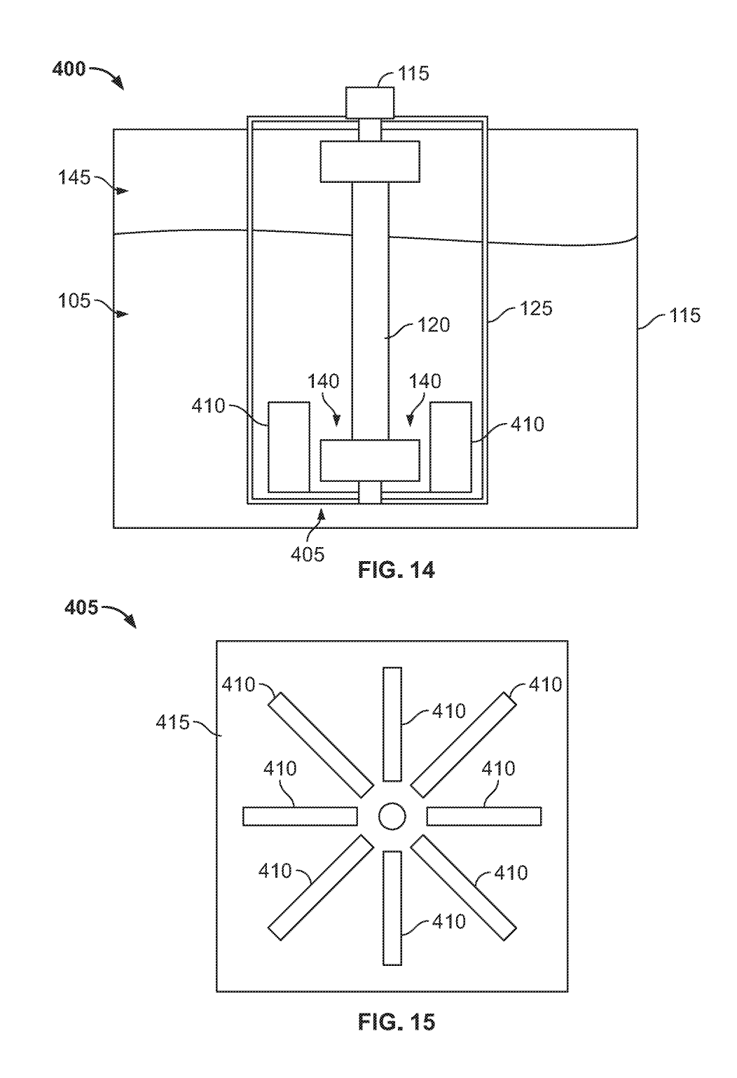

FIG. 14 illustrates an aeration system 400 according to other embodiments. The aeration system 400 includes a motor 115, an aerator 120, and a frame 125. The motor 115, aerator 120, and frame 125 may be substantially similar to the embodiments described above. Additionally, in some embodiments, the aeration system 400 may operate substantially similar to aeration system 100 discussed above. Additionally, components of the aeration system 400 may be interchangeable with the above described embodiments.

In some embodiment, the aeration system 400 further includes a stator 405 having one or more fins 410. As illustrated, in some embodiments, the stator 405 is located proximate the one or more outputs 140 of the aerator 120.

FIG. 15 illustrates a top view of the stator 405 and fins 410 according to some embodiments. In some embodiments, the stator 405 includes a base 415, with fins 410 coupled to the base 415. In the illustrated embodiments, the fins 410 are positioned on the base 415 in a circular fashion and equally spaced apart. However, in other embodiments, there may be more or less fins 410, and they may be unequally spaced, and/or spaced in a non-circular fashions (for example, in a square fashion, rectangular fashion, elliptical fashion, etc.). Additionally, in some embodiments, the fins 410 are positioned a predetermined distance (for example, 0.5 inch to 1 inch) from the outputs 140.

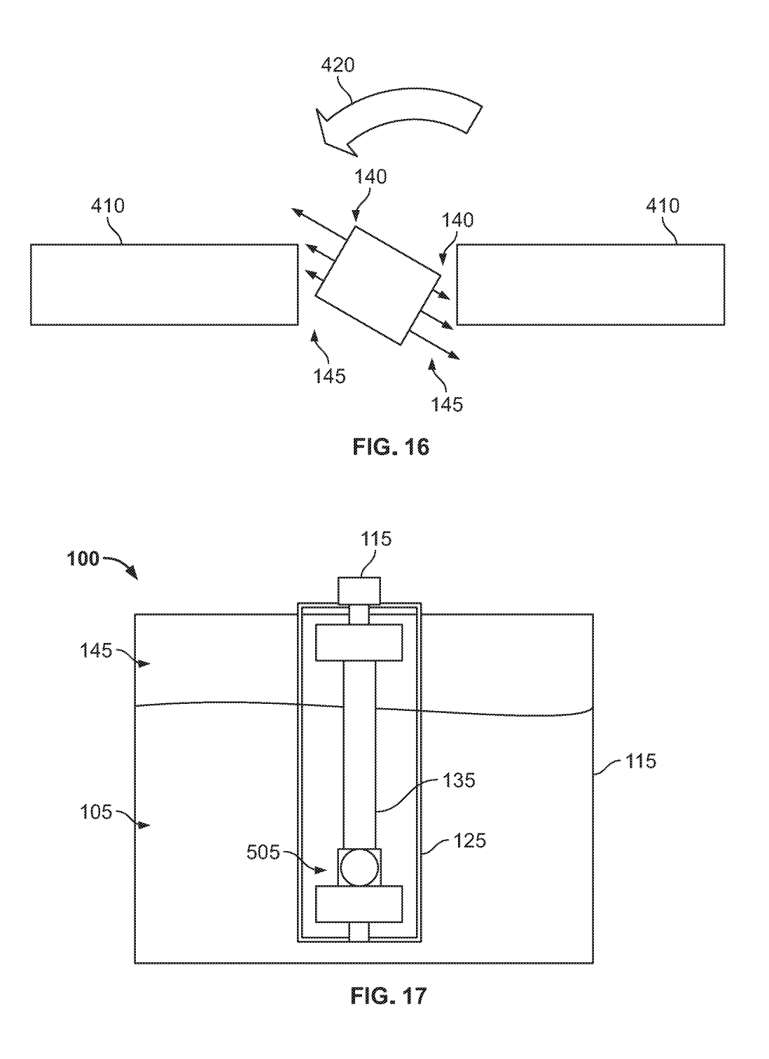

FIG. 16 illustrates a top view of outputs 140 passing by fins 410 of the stator 405 according to some embodiments. FIG. 16 illustrates two fins 410 for illustrative purposes and in some embodiments (such as FIG. 15), multiple fins 410 may be used. As illustrated, the outputs 140 turn in a direction (illustrated by arrow 420). As explained in greater detail above, as the outputs 140 turn in the direction, the second fluid 145 (illustrated by arrows projected from outputs 140) is output from outputs 140.

Additionally, in the aeration system 400, as the outputs 140 turns in the direction (illustrated by arrow 420), the second fluid 145 may be sheared by fins 410. In some embodiments, as the second fluid 145 is sheared by fins 410, a Venturi-effect is produced. For example, as the outputs 140 pass by the fins 410, the flow of the second fluid 145 is constricted, resulting in an increase in velocity of the second fluid 145 as the second fluid 145 passes by the fins 410.

FIG. 17 illustrates an aeration system 500 according to other embodiments. The aeration system 500 includes a motor 115, an aerator 120, and a frame 125. The motor 115, aerator 120, and frame 125 may be substantially similar to the embodiments described above. Additionally, in some embodiments, the aeration system 500 may operate substantially similar to aeration systems discussed above. Additionally, components of the aeration system 500 may be interchangeable with the above described embodiments (including, but not limited to the stator 405 of aeration system 400). In some embodiment, the aeration system 500 further includes an output apparatus 505 in fluid communication with intermediary portion 135.

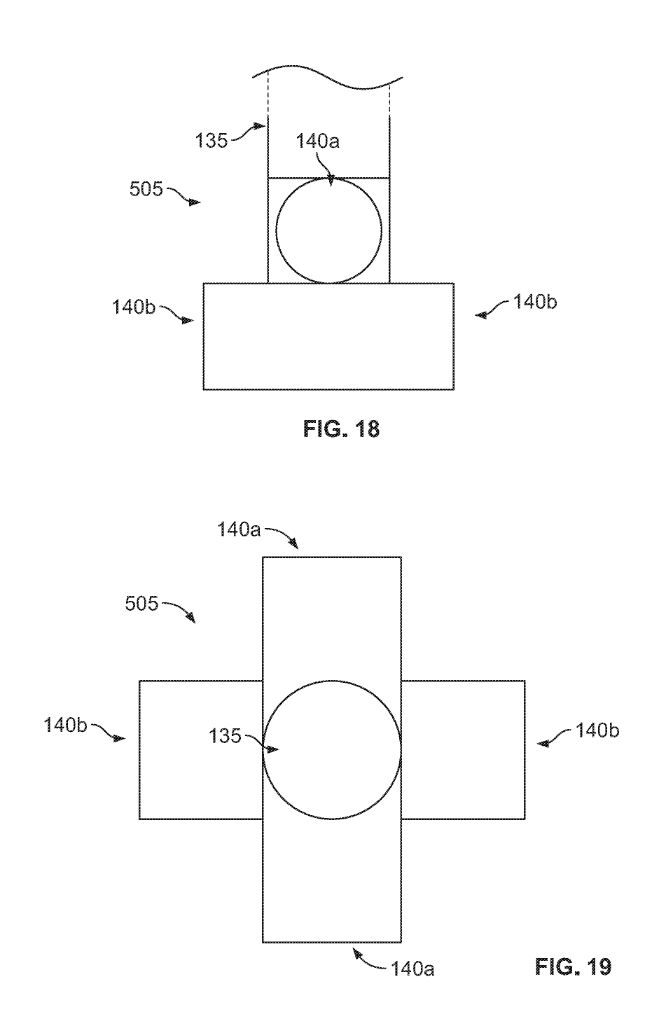

FIGS. 18 and 19 illustrate the output apparatus 505 according to some embodiments. As illustrated, the output apparatus 505 may include a first set of outputs 140a and a second set out outputs 140b. In some embodiments, the outputs 140a, 140b are substantially similar to outputs 140 discussed above.

As illustrated in the embodiment of FIG. 19, the first set of outputs 140a are positioned substantially perpendicular to the second set of output 140b. However, in other embodiments, the outputs 140a, 140b may be positioned at a variety of angles (including but not limited to 30° angles, 45° angles, etc.). Additionally, in some embodiments, output apparatus 505 may include three or more sets of outputs spaced at a variety of angles.

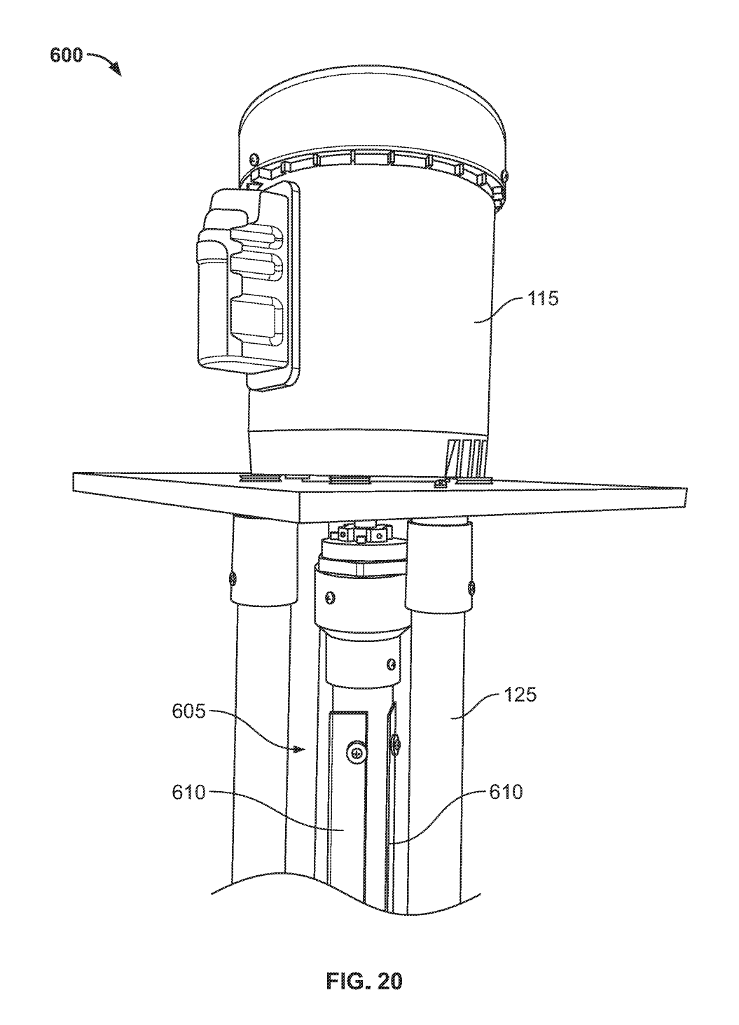

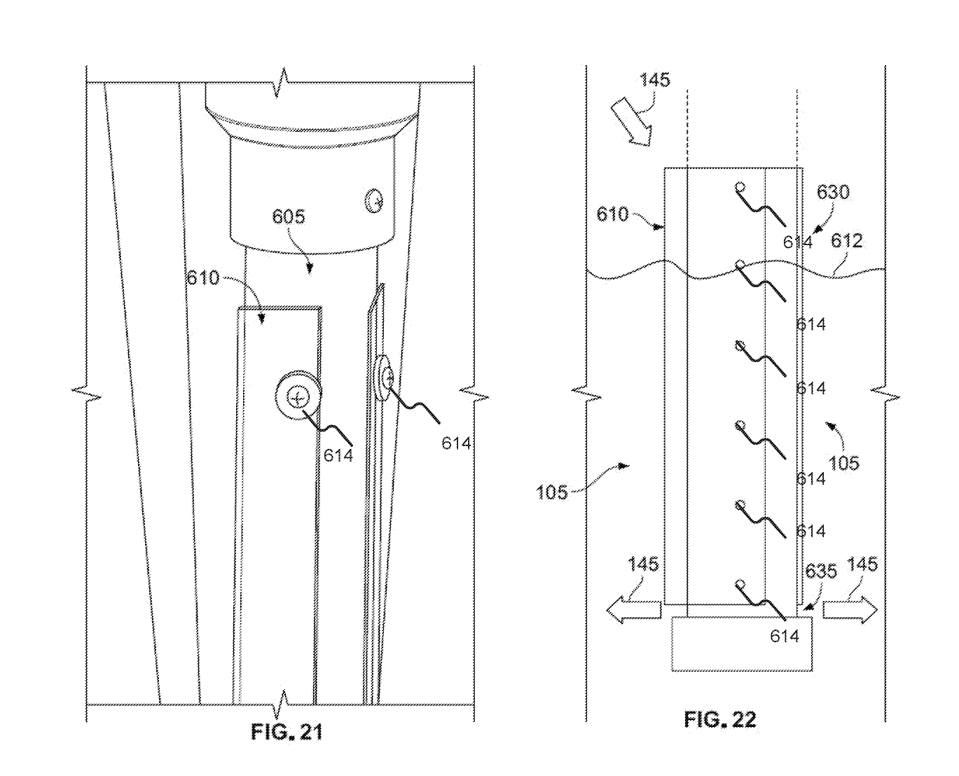

FIGS. 20-24 illustrate an aeration system 600 according to some embodiments. The aeration system 600 includes a motor 115 and a frame 125. The motor 115 and frame 125 may be substantially similar to the embodiments described above. In some embodiments, the motor 115 may provide approximately ½ horsepower. Additionally, in some embodiments, the aeration system 600 may operate substantially similar to aeration systems discussed above. Furthermore, components of the aeration system 600 may be interchangeable with the above described embodiments (including, but not limited to the stator 405 of aeration system 400).

The aeration system 600 may include an aerator 605 having one or more fins, or vanes, 610 (for example, 610a-610d). As illustrated in FIG. 22, when the aeration system 600 is placed in the fluid 105, a first, or top, portion of the vanes 610 are above the fluid 105, while a second, or bottom, portion of the vanes 610 are below a surface 612 of the fluid 105. In some embodiments, the vanes 610 are formed of polycarbonate. In other embodiments, the vanes 610 are formed of a plastic material. In yet other embodiments, the vanes 610 may be formed of a metallic material. Although illustrated as being coupled to a center portion of the aerator 605 via one or more fasteners, in some embodiments, the vanes 610 may be integrally formed with the center portion and/or coupled via other means.

In the illustrated embodiment, the one or more vanes 610 are coupled to a rotator 620 of the aerator 605 via attachments (for example, but not limited to, screws) 614. In some embodiments, the one or more vanes 610 are coupled to the rotator 620 such that the one or more vanes 610 extend from the rotator 620 at an angle of approximately 90°. In some embodiments, the vanes 610 proximate each other extend at an angle perpendicular from each other. For example, vane 610a may extend in a first direction, while vane 610b may extend in a second direction perpendicular to the first direction. As a further example, vanes 610a, 610c may be parallel to each other; vanes 610b, 610d may be parallel to each other; and vanes 610a, 610c may be perpendicular to vanes 610b, 610d.

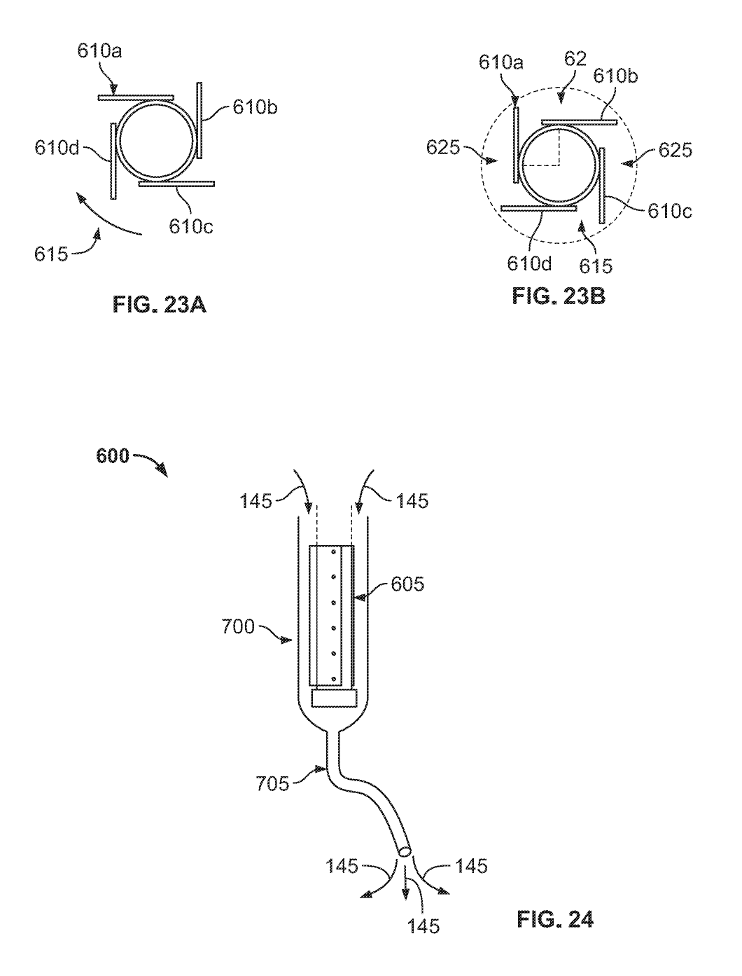

As illustrated in FIG. 23A, the aerator 605 rotates in a direction illustrated by arrow 615. As the aerator 605 is rotated, one or more pockets (such as, but not limited to, an air pocket), or channels, 625 may be formed by the rotating vanes 610. In some embodiments, the channels 625 provide fluid communication between an input 630 and an output 635 (illustrated generally in FIG. 22). The input 630 may formed proximate the top portion of the rotating vanes 610 and the output 635 may be formed proximate the bottom portion of the rotating vanes 610.

The second fluid 145 may then flow from the input 630 through the one or more channel 625 formed by the rotating vanes 610, and into the first fluid 105 (via, for example, the output 635).

FIG. 24 illustrates the aeration system 600 being used as a pump (for example, but not limited to, an air lift pump) according to some embodiments. In such an embodiment, an enclosure 700 may surround the aerator 605. The enclosure 700 may be in fluid communication with a hose 705. In operation, the second fluid 145 is pumped via the aerator 605 through the enclosure 700 and through the hose 705. The second fluid 145 may then be output (for example, but not limited, into the first fluid 105) from the hose 705.

In some embodiments, hose 705 may be substantially the same size (for example, the same circumference) as enclosure 700. Additionally, in some embodiments, aeration system 600 may further include one or more stators (for example, stator 405 including a base 415 having one or more fins 410).

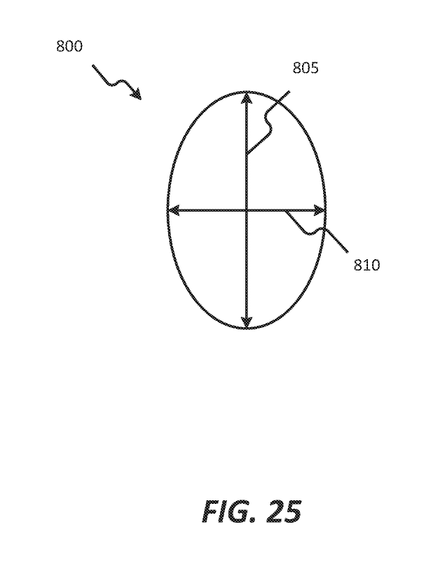

With respect to any of the embodiments described above, a system may include an aerator having a shape, the shaped aerator configured to rotate with respect to, and proximate to, a stator (for example, stator 405 and/or frame 125). For example, the shape of the rotating aerator may be, but is not limited to, a polygonal-shape, a flat-shape, an elliptical-shape, and a shape having first and second axis, wherein the shape may be symmetrical along the first axis, symmetrical along the second axis, and asymmetrical between the first axis and the second axis. FIG. 25 illustrates a shape 800 of an aerator according to some embodiments, the shape 800 may include a first axis 805 and a second axis 810. The shape 800 may be symmetrical along the first axis 805 and may be symmetrical along the second axis 810. However, in some embodiments, the shape 800 may be asymmetrical between the first axis 805 and the second axis 810.

During operation of any of the above-mentioned embodiments, as the aerator (having any shape mentioned above) rotates proximate a stator, zones of pressure may be created. For example, as a tip, or edge, of a first axis of an aerator passes by a stator, pressure may drop rapidly. The pressure then may increase as the same tip, or edge, approaches the same stator, or another stator within the rotational path. As the pressure drops, a vacuum-effect may occur and the second fluid 145 is sucked into the first fluid 105.

In some embodiments, a froth may be created by aerating the first fluid 105 with the second fluid 145. As the froth is pressurized (for example, by the rotation of an aerator proximate a stator), heat may be produced. The heated froth (for example, heated aerated fluid) may then rise, thus increasing aeration of fluid 105.

In some embodiments, as the froth is pressurized (for example, by the rotation of an aerator proximate a stator), the froth may be compressed/decompressed. Such compression/decompression, may result in more efficient aeration of fluid 105.

Thus, embodiments provide, among other things, a system and method for aerating and/or mixing a fluid, and/or a fluid pump. One benefit of the embodiments described above include that approximately no thrust is produced, thereby requiring a low-powered motor and reducing wear on the motor.

What is claimed is:

1. An aeration system comprising:
a frame;
an aerator supported by the frame, the aerator including an input and an output, the aerator is configured to
rotate with respect to the frame, and
upon rotating, receive a first fluid at the input and output the first fluid into a second fluid at the output.

2. The aeration system of claim 1, wherein the aerator further includes one or more vanes.

3. The aeration system of claim 2, wherein upon rotating, the input is formed by a top portion of the one or more vanes and the output is formed by a bottom portion of the one or more vanes.

4. The aeration system of claim 3, wherein the top portion of the one or more vanes is located above a surface of the second fluid and the bottom portion of the one or more vanes is located below the surface of the second fluid.

5. The aeration system of claim 2, wherein the one or more vanes include a first vane extending in a first direction and a second vane extending in a second direction, the first direction perpendicular to the second direction.

6. The aeration system of claim 1, wherein the input and the output are in fluid communication via a channel.

7. The aeration system of claim 6, wherein the channel is formed by rotation of one or more vanes.

8. The aeration system of claim 1, wherein the input includes one or more scoops.

9. The aeration system of claim 8, wherein the one or more scoops include a first scoop projected in a first direction and a second scoop projected in a second direction, the first direction opposite the second direction.

10. The aeration system of claim 1, further comprising a stator including one or more fins proximate the output.

11. The aeration system of claim 10, further comprising a second output perpendicular to the output.

12. A method of aerating a first fluid with a second fluid, the method comprising:
providing an aerator including an input and an output;
rotating the aerator; and
upon rotating the aerator, receiving the first fluid at the input and outputting the first fluid into the second fluid at the output.

13. The method of claim 12, wherein the aerator further includes one or more vanes.

14. The method of claim 13, wherein upon rotating, the input is formed by a top portion of the one or more vanes and the output is formed by a bottom portion of the one or more vanes.

15. The method of claim 14, further comprising:
placing the top portion of the one or more vanes above a surface of the second fluid; and
placing the bottom portion of the one or more vanes below the surface of the second fluid.

16. The method of claim 13, wherein the one or more vanes include a first vane extending in a first direction and a second vane extending in a second direction, the first direction perpendicular to the second direction.

17. The method of claim 12, wherein upon rotation of the aerator, a channel is formed by one or more vanes.

18. The method of claim 12, wherein the input includes one or more scoops.

19. The method of claim 18, wherein the one or more scoops include a first scoop projected in a first direction and a second scoop projected in a second direction, the first direction opposite the second direction.

20. The method of claim 12, further comprising
providing a stator including one or more fins proximate the output.
